(19) United States
(12) Patent Application Publication
(10) Pub. No.: US 2021/0309148 A1
(43) Pub. Date: Oct. 7, 2021

(54) PERIPHERAL MONITORING APPARATUS

(71) Applicant: AISIN SEIKI KABUSHIKI KAISHA, Kariya-shi, Aichi-ken (JP)

(72) Inventor: Kazuya WATANABE, Anjo-shi, Aichi-ken (JP)

(73) Assignee: AISIN SEIKI KABUSHIKI KAISHA, Kariya-shi, Aichi-ken (JP)

(21) Appl. No.: 16/754,842

(22) PCT Filed: Oct. 3, 2018
(86) PCT No.: PCT/JP2018/036999

§ 371 Date: Apr. 9, 2020

(30) Foreign Application Priority Data
Oct. 12, 2017 (JP) 2017-198846

(51) Int. Cl. B60R 1/00; H04N 7/18; G06K 9/00

(52) U.S. Cl. CPC B60R 1/00; H04N 7/18; G06K 9/00791; B60R 2300/806; B60R 2300/304; B60R 2300/307; B60R 2300/8066

(57) ABSTRACT

A peripheral monitoring apparatus includes a hardware processor that: acquires captured image data obtained by capturing, from a towing vehicle to which a towed vehicle is coupleable, a region behind the towing vehicle; acquires coupling information representing whether or not the towed vehicle is coupled to the towing vehicle; generates a reference line to be a reference for a movement of the towing vehicle when the towing vehicle moves backward; and switches display modes of the reference line to be displayed after being superimposed on an image being based on the captured image data, the switching of the display modes being performed between a case where the towed vehicle is coupled to the towing vehicle and a case where the towed vehicle is not coupled to the towing vehicle.

### TECHNICAL FIELD

Embodiments of the present invention relate to a peripheral monitoring apparatus.

### BACKGROUND ART

Conventionally, an in-vehicle camera device has been proposed, in which a predicted trajectory, which is calculated based on a steering angle of a vehicle, is displayed on a monitor after being superimposed on a video behind the vehicle captured by an in-vehicle camera. The in-vehicle camera device displays a predicted trajectory indication of a portion overlapping an obstacle so as to differentiate it from a predicted trajectory indication of a portion not overlapping the obstacle. By such display, a sense of distance to the obstacle behind the vehicle in the predicted trajectory can be appropriately given to a driver.

### CITATION LIST

### Patent Literature

Patent Document 1: Japanese Laid-open Patent Publication No. 2005-236540

### SUMMARY OF INVENTION

### Problem to be Solved by Invention

Recently, attention to a towing vehicle (tractor) that can tow a towed vehicle (trailer) tends to increase. Steering performed when the towed vehicle is coupled to the towing vehicle, in particular, such steering in backward moving operation, is more difficult than that when the towed vehicle is not coupled to the towing vehicle, and skill of a driving operation is required. Therefore, it is conceivable to use the predicted trajectory as in the conventional technology. However, when a conventional trajectory line is applied to the towing vehicle to which the towed vehicle is coupled, the predicted trajectory overlaps the towed vehicle. For this reason, display contents are uncomfortable or it is difficult to determine whether the predicted trajectory is a predicted trajectory of the towing vehicle or a predicted trajectory of the towed vehicle. As a result, it may be difficult to use the conventional trajectory line. Therefore, when it is possible to provide a peripheral monitoring apparatus capable of displaying a trajectory line (for example, a reference line) to be easily used at the time of a backward movement even in the towing vehicle to which the towed vehicle can be coupled, this is meaningful because driving of the towing vehicle and driving when the towed vehicle is coupled are facilitated.

### Means for Solving Problem

An peripheral monitoring apparatus according to an embodiment of the present invention includes: an image acquisition unit configured to acquire captured image data obtained by capturing, from a towing vehicle to which a towed vehicle is coupleable, a region behind the towing vehicle; a state acquisition unit configured to acquire coupling information representing whether or not the towed vehicle is coupled to the towing vehicle; a generation unit configured to generate a reference line to be a reference for a movement of the towing vehicle when the towing vehicle moves backward; and a display mode control unit configured to switch display modes of the reference line to be displayed after being superimposed on an image being based on the captured image data, the switching of the display modes being performed between a case where the towed vehicle is coupled to the towing vehicle and a case where the towed vehicle is not coupled to the towing vehicle. According to this configuration, the display mode of the reference line changes between the case where the towing vehicle is coupled to the towed vehicle and the case where the towing vehicle is not coupled to the towed vehicle. Thus, it is easy to recognize a change between display contents before the coupling and display contents after the coupling. As a result, it is possible to pay attention to the reference line, and to recognize that the reference line indicates a reference of the backward movement of the towing vehicle, so that convenience can be enhanced.

In the peripheral monitoring apparatus according to an embodiment, the state acquisition unit is configured to further acquire current steering angle information of the towing vehicle, the generation unit is configured to generate, as at least part of the reference line, a trajectory line representing at least part of a backward movement trajectory of the towing vehicle when the towing vehicle moves backward, the trajectory line being generated based on the steering angle information, and the display mode control unit is configured to switch display modes of the trajectory line. According to this configuration, for example, it is easy to understand the behavior of the towing vehicle at the time of the backward movement, and it is possible to make it easier to perform driving when the towed vehicle is coupled to the towing vehicle and when the towed vehicle is not coupled to the towing vehicle.

In the peripheral monitoring apparatus according to an embodiment, the display mode control unit is configured to perform display such that a second farthest display position is closer to a rear portion of the towing vehicle than a first farthest display position, the first farthest display position is a farthest position from the rear portion of the towing vehicle out of position of the reference line displayed when the towed vehicle is not coupled to the towing vehicle, and the second farthest display position is a farthest position from the rear portion of the towing vehicle out of position of the reference line displayed when the towed vehicle is coupled to the towing vehicle. According to this configuration, for example, the farthest display position (second farthest display position) of the reference line when the towed vehicle is coupled to the towing vehicle is closer than the farthest display position (first farthest display position) when the towed vehicle is not coupled. As a result, it becomes easier to distinguish the reference lines between the case where the towed vehicle is coupled and the case where the towed vehicle is not coupled. Further, when the towed vehicle is not coupled to the towing vehicle, the reference line is displayed as far as a distant place behind the towing vehicle. As a result, it is easy to perform movement prediction to the distant place when the towing vehicle is moved backward. Further, when the towed vehicle is coupled, the farthest display position of the reference line becomes closer, so that the towed vehicle and the reference line hardly overlap on a display screen. As a result, it is possible to make it easier to recognize that the reference line is the reference of the movement position when the towing vehicle moves backward.

In the peripheral monitoring apparatus according to an embodiment, the display mode control unit is configured to determine the second farthest display position of the reference line, based on a coupling distance between the towing vehicle and the towed vehicle. According to this configuration, for example, the display length of the reference line can be determined such that the reference line displayed to the second farthest display position does not overlap a body of the towed vehicle. As a result, it becomes easy to clearly indicate that the displayed reference line is the reference line for the towing vehicle. Further, the contents of the display screen can be simplified.

In the peripheral monitoring apparatus according an embodiment, when the display modes of the reference line are switched, the display mode control unit is configured to include part of a first reference line in a second reference line, the first reference line being displayed when the towed vehicle is not coupled to the towing vehicle, the second reference line being displayed when the towed vehicle is coupled to the towing vehicle. According to this configuration, for example, there is common part between the first reference line displayed as far as the distant place when the towed vehicle is not coupled and the second reference line displayed when the towed vehicle is coupled, so that it is easy to recognize a relation between both sides.

### BRIEF DESCRIPTION OF DRAWINGS

FIG. 1 is a side view schematically illustrating an example of a coupled state of a towed vehicle and a towing vehicle equipped with a peripheral monitoring apparatus according to an embodiment;

FIG. 2 is a top view schematically illustrating an example of a coupled state of the towed vehicle and the towing vehicle equipped with the peripheral monitoring apparatus according to the embodiment;

FIG. 3 is an exemplary block diagram of a configuration of a peripheral monitoring system including the peripheral monitoring apparatus according to the embodiment;

FIG. 4 is an exemplary block diagram of a configuration of a CPU of the peripheral monitoring apparatus according to the embodiment;

FIG. 5 is a schematic diagram illustrating an example of an image representing a trajectory line as an example of a reference line when the towed vehicle is not coupled to the towing vehicle, in the peripheral monitoring apparatus according to the embodiment;

FIG. 6 is a schematic diagram illustrating an example of an image representing a trajectory line as an example of a reference line when the towed vehicle is coupled to the towing vehicle, in the peripheral monitoring apparatus according to the embodiment;

FIG. 7 is a schematic diagram illustrating an example of a change in a display mode of a trajectory line as an example of a reference line when the towed vehicle is not coupled to the towing vehicle and when the towed vehicle is coupled to the towing vehicle, in the peripheral monitoring apparatus according to the embodiment;

FIG. 8 is a schematic diagram illustrating an example of a change in another display mode of a trajectory line as an example of a reference line when the towed vehicle is not coupled to the towing vehicle and when the towed vehicle is coupled to the towing vehicle, in the peripheral monitoring apparatus according to the embodiment;

FIG. 9 is a schematic diagram illustrating an example of a change in other display mode of a trajectory line as an example of a reference line when the towed vehicle is not coupled to the towing vehicle and when the towed vehicle is coupled to the towing vehicle, in the peripheral monitoring apparatus according to the embodiment; and

FIG. 10 is a flowchart illustrating an example of a display processing procedure of a trajectory line as an example of a reference line by the peripheral monitoring apparatus according to the embodiment.

### DESCRIPTION OF EMBODIMENTS

Hereinafter, exemplary embodiments of the present invention are disclosed. Configurations of the embodiments described below and functions, results, and effects provided by the configurations are exemplary. The present invention can be implemented by configurations other than the configurations disclosed in the following embodiments, and can obtain at least one of various effects based on a basic configuration and derivative effects.

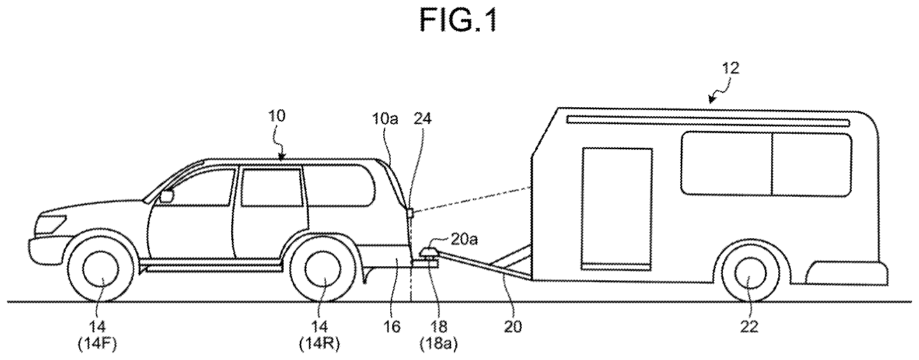

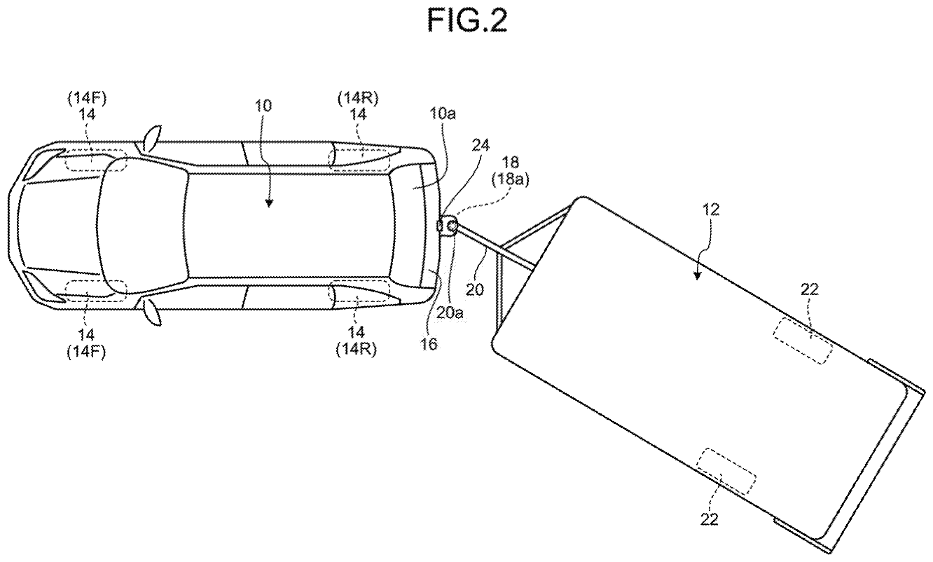

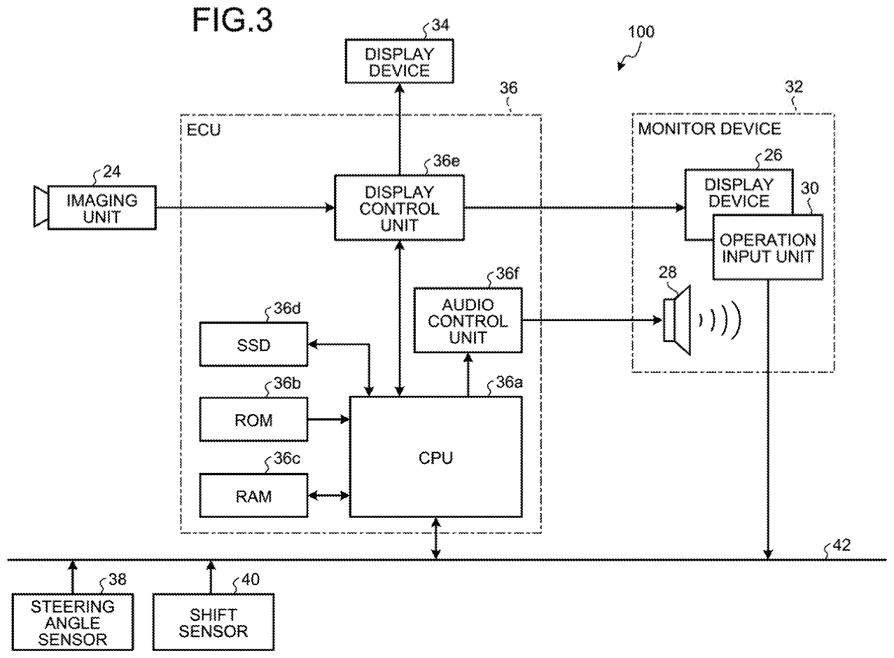

FIG. 1 is a side view illustrating a towing vehicle 10 equipped with a peripheral monitoring apparatus according to an embodiment and a towed vehicle 12 towed by the towing vehicle 10. In FIG. 1, a leftward direction of a plane of paper is defined as the front based on the towing vehicle 10, and a rightward direction of the plane of paper is defined as the rear based on the towing vehicle 10. FIG. 2 is a top view of the towing vehicle 10 and the towed vehicle 12 illustrated in FIG. 1. Further, FIG. 3 is an exemplary block diagram of a configuration of a peripheral monitoring system 100 including the peripheral monitoring apparatus mounted on the towing vehicle 10.

The towing vehicle 10 may be, for example, a vehicle (an internal combustion engine vehicle) using an internal combustion engine (an engine, not illustrated) as a driving source, may be a vehicle (an electric vehicle, a fuel cell vehicle, or the like) using an electric motor (motor, not illustrated) as a driving source, or may be a vehicle (a hybrid vehicle) using both of them as driving sources. The towing vehicle 10 may be a multipurpose vehicle for sports (Sport Utility Vehicle: SUV) illustrated in FIG. 1, or may be a so-called “pickup truck” in which a luggage carrier is provided behind the vehicle. Further, it may be a general passenger car. The towing vehicle 10 can be equipped with various transmissions, and can be equipped with various devices (systems, components, and the like) necessary for driving the internal combustion engine and the electric motor. Further, the type, the number, the layout, and the like of devices related to driving of wheels 14 (front wheels 14F and rear wheels 14R) in the towing vehicle 10 can be variously set.

A towing device 18 (hitch) for towing the towed vehicle 12 protrudes from a lower portion of a center portion of a rear bumper 16 of the towing vehicle 10, for example, in a vehicle width direction. The towing device 18 is fixed to, for example, a frame of the towing vehicle 10. As an example, the towing device 18 includes a hitch ball 18a having a spherical tip erected in in a vertical direction (a vehicle vertical direction), and the hitch ball 18a is covered with a coupler 20a provided at the tip of a coupling member 20 fixed to the towed vehicle 12. As a result, the towing vehicle 10 and the towed vehicle 12 are coupled, and the towed vehicle 12 can swing (turn) in the vehicle width direction with respect to the towing vehicle 10. In other words, the hitch ball 18a conducts movements of the front, the rear, the left, and the right to the towed vehicle 12 (the coupling member 20), and receives the power of acceleration and deceleration.

The towed vehicle 12 may be of, for example, as illustrated in FIG. 1, a boarding type containing at least one of a boarding space, a living section, a storage space, and the like, or may be of a luggage carrier type for loading luggage (for example, a container or a boat). The towed vehicle 12 illustrated in FIG. 1 includes a pair of trailer wheels 22 as an example. The towed vehicle 12 in FIG. 1 is a driven vehicle including a driven wheel that does not include a driving wheel or a steering wheel.

An imaging unit 24 is provided on a wall below a rear hatch 10a on the rear side of the towing vehicle 10. The imaging unit 24 is, for example, a digital camera containing an imaging element such as a charge coupled device (CCD) or a CMOS image sensor (CIS). The imaging unit 24 can output moving image data (captured image data) at a predetermined frame rate. The imaging unit 24 has a wide-angle lens or a fish-eye lens, and can image a range of 140° to 220°, for example, in a horizontal direction. Further, an optical axis of the imaging unit 24 is set obliquely downward. Thus, the imaging unit 24 sequentially images a region (for example, a range indicated by a two-dot chain line, see FIG. 1) including a rear end of the towing vehicle 10, the coupling member 20, and at least a front end of the towed vehicle 12, and outputs an imaged image as image data. The captured image data captured by the imaging unit 24 can be used for recognition of the towed vehicle 12 and detection of a coupling state (for example, a coupling angle, presence/absence of coupling, and the like) of the towing vehicle 10 and the towed vehicle 12. In this case, since the coupling state or the coupling angle between the towing vehicle 10 and the towed vehicle 12 can be obtained on the basis of the captured image data captured by the imaging unit 24, a system configuration can be simplified, and a load of calculation processing or image processing can be reduced. The towing vehicle 10 may be provided with an imaging unit that images the front or the side. Further, an imaging unit may be provided on the side or the rear of the towed vehicle 12. The calculation processing or the image processing may be executed on the basis of captured image data obtained by a plurality of imaging units to generate an image with a wider viewing angle or generate a virtual overlooking image (plane image) when the towing vehicle 10 is viewed from the above.

Further, as illustrated in FIG. 3, a display device 26, an audio output device 28, and the like are provided in a vehicle interior of the towing vehicle 10. The display device 26 is, for example, a liquid crystal display (LCD), an organic electroluminescent Display (OELD), or the like. The audio output device 28 is, for example, a speaker. In the present embodiment, as an example, the display device 26 is covered with a transparent operation input unit 30 (for example, a touch panel or the like). A driver (user) can visually recognize video (image) displayed on a screen of the display device 26 via the operation input unit 30. Further, the driver touches, pushes, or moves the operation input unit 30 with a finger or the like at a position corresponding to the video (image) displayed on the screen of the display device 26, thereby performing an operation input (instruction input). Further, in the present embodiment, as an example, the display device 26, the audio output device 28, the operation input unit 30, and the like are provided in a monitor device 32 located at a center portion of a dashboard in the vehicle width direction (horizontal direction). The monitor device 32 can be provided with an operation input unit (not illustrated) such as a switch, a dial, a joystick, and a push button. Further, an audio output device (not illustrated) can be provided at another position in the vehicle interior different from a position of the monitor device 32, and audio can be output from the audio output device 28 of the monitor device 32 and another audio output device. Further, in the present embodiment, as an example, the monitor device 32 is also used as a navigation system and an audio system. Alternatively, a monitor device for a peripheral monitoring apparatus may be provided separately from these systems.

When the towing vehicle 10 moves backward, the display device 26 can display a reference line representing a reference of a movement (position to be moved) of at least part of the towing vehicle 10. Further, the display device 26 can switch display modes of the reference line between a case where the towed vehicle 12 is coupled to the towing vehicle 10 and a case where the towed vehicle 12 is not coupled to the towing vehicle 10. The details of the display contents of the display device 26 will be described later.

A display device 34 differing from the display device 26 may be provided in the vehicle interior of the towing vehicle 10. The display device 34 may be provided, for example, on an instrument panel of the dashboard. A size of a screen of the display device 34 can be smaller than a size of a screen of the display device 26. The display device 34 can simply display the reference line together with icons and indicators corresponding to the towing vehicle 10 and the towed vehicle 12. An amount of information displayed on the display device 34 may be smaller than an amount of information displayed on the display device 26. The display device 34 is, for example, an LCD, an OELD, or the like. Further, the display device 34 may be configured by an LED or the like.

In the present embodiment, the reference line is a guide line as a reference for a movement (movement position) of at least part of the towing vehicle 10 when the towing vehicle 10 moves backward. The reference line may be, for example, a fixed reference line representing a predetermined position behind the towing vehicle 10, or may be a variable reference line that indicates a reference of a movement position to be reached when the towing vehicle 10 turns or moves straight based on a current steering angle of the towing vehicle 10. In the variable reference, a display position changes in accordance with a steering angle. The fixed reference line is a fixed line representing a predetermined position behind the towing vehicle 10 on the display device 26 regardless of the steering angle of the towing vehicle 10. The fixed reference line is, for example, a right end extension line linearly extending backward from a right rear end of the towing vehicle 10 and a left end extension line linearly extending backward from a left rear end, and can include a vehicle width guide line representing a vehicle width of the towing vehicle 10 by a pair of right end extension line and left end extension line. Further, the fixed reference line can include a distance reference line representing a separation distance from the rear bumper 16. On the other hand, the variable reference line is a right end extension line and a left end extension line displayed in a turning direction when the towing vehicle 10 turns while the towing vehicle 10 moves backward according to the steering angle of the towing vehicle 10, and can include a vehicle width guide line representing a vehicle width curved on the basis of the turning direction. When the vehicle moves straight, the vehicle width guide line is also displayed by a straight line. The variable reference line can include a distance reference line representing a position of the rear bumper 16 at the movement position of the towing vehicle 10 when the towing vehicle 10 moves backward (performs turning movement). The distance reference line is used as a separation distance from the rear bumper 16 of the towing vehicle 10 at a current position. In this case, the distance reference line is arranged in the turning direction. The operation input unit 30 operable by the driver allows selecting which of the fixed reference line and the variable reference line is displayed on the display device 26. Further, both the fixed reference line and the variable reference line may be displayed simultaneously. In the following embodiment, an example in which the variable reference line is displayed as an example of the reference line will be described. Note that, in the following description, the variable reference line, in which the display position changes according to the steering angle, is referred to as a “trajectory line”.

In the peripheral monitoring system 100 (peripheral monitoring apparatus), an electronic control unit (ECU) 36, a monitor device 32, a steering angle sensor 38, a shift sensor 40, and the like are electrically connected over an in-vehicle network 42 functioning as an electric telecommunication line. The in-vehicle network 42 is configured as, for example, a controller area network (CAN). The ECU 36 receives detection results from the steering angle sensor 38, the shift sensor 40, and the like, operation signals from the operation input unit 30, and the like over the in-vehicle network 42, and can reflect them in control.

The ECU 36 has, for example, a central processing unit (CPU) 36a, a read only memory (ROM) 36b, a random access memory (RAM) 36c, a solid state drive (SSD) 36d (or flash memory), a display control unit 36e, an audio control unit 36f, and the like. The CPU 36a can execute image processing related to images displayed on the display device 26 and the display device 34, for example. Further, the CPU 36a can execute various calculation processing and control, such as generation processing for generating a trajectory line, which is an example of a reference line to be a reference for the movement (movement position) at the time of the backward movement displayed when the towing vehicle 10 moves backward, according to the steering angle of the towing vehicle 10 or the presence or absence of coupling of the towed vehicle 12 and display processing for changing a display mode thereof. The CPU 36a can read a program installed and stored in a non-volatile storage device such as the ROM 36b, and execute calculation processing according to the program. The RAM 36c temporarily stores various data used in the calculation in the CPU 36a. Further, the display control unit 36e mainly executes combining of image data displayed on the display devices 26 and 34 in the calculation processing in the ECU 36. Further, the audio control unit 36f mainly performs processing of audio data output from the audio output device 28 in the calculation processing in the ECU 36. Further, the SSD 36d is a rewritable non-volatile storage unit, and can store data even when a power supply of the ECU 36 is turned off. The CPU 36a, the ROM 36b, the RAM 36c, and the like can be integrated in the same package. Further, the ECU 36 may have a configuration in which another logical operation processor or another logical circuit such as a digital signal processor (DSP) is used instead of the CPU 36a. Further, a hard disk drive (HDD) may be provided instead of the SSD 36d, and the SSD 36d or the HDD may be provided separately from the ECU 36.

The steering angle sensor 38 is, for example, a sensor that detects a steering amount (a steering angle of the towing vehicle 10) of a steering portion such as a steering wheel of the towing vehicle 10. The steering angle sensor 38 is configured by using, for example, a Hall element or the like. The ECU 36 acquires an amount of steering of the steering portion by the driver, an amount of steering of each wheel 14 at the time of automatic steering, and the like, from the steering angle sensor 38, and executes various controls. The steering angle sensor 38 detects a rotation angle of a rotation part included in the steering portion. The steering angle sensor 38 is an example of an angle sensor.

The shift sensor 40 is, for example, a sensor that detects a position of a movable unit of a shift operation unit (for example, a shift lever). The shift sensor 40 can detect a position of a lever, an arm, a button, or the like as the movable unit. The shift sensor 40 may include a displacement sensor or may be configured as a switch.

The configuration, the arrangement, the electrical connection form, and the like of the various sensors and the like described above are merely examples, and can be variously set (changed).

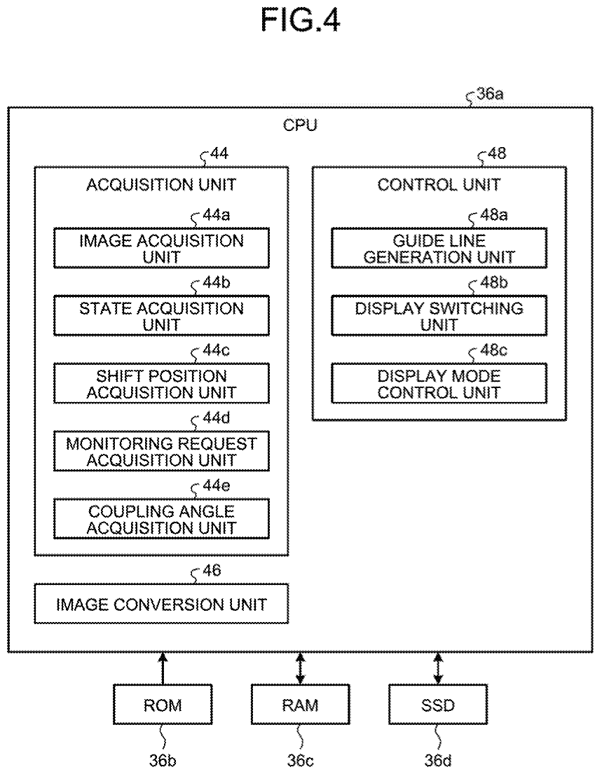

FIG. 4 is an exemplary block diagram of a configuration of the CPU 36a included in the ECU 36. The CPU 36a includes various modules for implementing generation processing for generating a trajectory line representing a backward movement trajectory as an example of the reference line, which is displayed when the towing vehicle 10 moves backward, and display processing for changing the display mode thereof. The various modules are implemented by reading a computer program installed and stored in a storage device, such as the ROM 36b, and executing the program by the CPU 36a. As illustrated in FIG. 4, the CPU 36a includes modules, for example, an acquisition unit 44, an image conversion unit 46, and a control unit 48.

The acquisition unit 44 acquires various information used for displaying a trajectory line representing a backward movement trajectory when the towing vehicle 10 moves backward on the display device 26. The acquisition unit 44 includes, for example, an image acquisition unit 44a, a state acquisition unit 44b, a shift position acquisition unit 44c, a monitoring request acquisition unit 44d, a coupling angle acquisition unit 44e, and the like.

The image acquisition unit 44a acquires captured image data obtained by capturing a rear region of the towing vehicle 10 by the imaging unit 24 installed in the rear portion of the towing vehicle 10. The imaging unit 24 is fixed to the rear portion of the towing vehicle 10, and an imaging direction and an imaging range are fixed. Thus, the rear bumper 16, the towing device 18 (hitch ball 18a), and the like of the towing vehicle 10 are captured in a predetermined position (for example, a lower end region of a screen) of an image that is based on the captured image data captured by the imaging unit 24. When the towed vehicle 12 is coupled to the towing vehicle 10, part of a front end of the towed vehicle 12 and the coupling member 20 (coupler 20a) are captured in the image in a predetermined region based on the rear bumper 16 and the like. The image acquisition unit 44a may acquire captured image data from an imaging unit capturing a front image of the towing vehicle 10, an imaging unit capturing left and right side images of the towing vehicle 10, an imaging unit capturing left and right side images of the towed vehicle 12, and an imaging unit capturing a rear image of the towed vehicle 12, in addition to an image (rear image) of a rear region by the imaging unit 24. The image conversion unit 46 can generate overlooking images representing peripheral conditions of the towing vehicle 10 and the towed vehicle 12, on the basis of captured image data obtained by capturing surrounding of the towing vehicle 10 and the towed vehicle 12. Each image can be captured by an imaging unit having a configuration similar to that of the imaging unit 24. For example, the front image of the towing vehicle 10 can be captured by an imaging unit installed on the front bumper of the towing vehicle 10 or a front window in the vehicle interior. The left and right side images of the towing vehicle 10 can be captured by, for example, an imaging unit installed on a side mirror or the like of the towing vehicle 10. Similarly, the left and right side images of the towed vehicle 12 can be captured by, for example, imaging units installed on left and right sides of a body of the towed vehicle 12, and a rear image of the towed vehicle 12 can be captured by an imaging unit installed on a rear wall surface of the towed vehicle 12.

The state acquisition unit 44b acquires coupling information representing whether or not the towed vehicle 12 is coupled to the towing vehicle 10, and acquires current steering angle information of the towing vehicle 10. The state acquisition unit 44b may acquire, as the coupling information, information input by operating the operation input unit 30 by the driver of the towing vehicle 10 when the towed vehicle 12 is coupled, for example. Further, image processing may be performed on an image based on the captured image data representing the region behind the towing vehicle 10 acquired by the image acquisition unit 44a, and recognition information when the towed vehicle 12 can be recognized may be acquired as the coupling information. Further, a sensor may be provided in the towing device 18 to acquire, as the coupling information, detection information when coupling between the towing device 18 and the coupling member 20 can be detected. Further, when the towing vehicle 10 and the towed vehicle 12 are coupled, lighting control of a stop lamp, a direction indicator, a vehicle width lamp, and the like provided in the rear end of the towed vehicle 12 is performed on the basis of control of the towing vehicle 10. In this case, a signal representing that control lines between the towing vehicle 10 and the towed vehicle 12 are connected may be acquired as the coupling information. Further, as the steering angle information of the towing vehicle 10, a detection value detected by the steering angle sensor 38 is acquired. That is, a steering angle in a direction in which the driver is about to drive the towing vehicle 10 (the towed vehicle 12) is acquired. When only the fixed reference line is displayed on the display device 26, the state acquisition unit 44b may omit acquisition of the steering angle information.

The shift position acquisition unit 44c acquires whether the towing vehicle 10 is in a forward movable state or a backward movable state, on the basis of the position of the movable unit of the shift operation unit output by the shift sensor 40. When the steering angle information is acquired, the state acquisition unit 44b may use an acquisition result of the shift position acquisition unit 44c to determine that the current steering angle is a steering angle in the forward movable state or a steering angle in the backward movable state.

The monitoring request acquisition unit 44d acquires information representing whether or not a transition to a peripheral monitoring mode for performing peripheral monitoring, in particular, monitoring of the rear region of the towing vehicle 10 (moving support with a trajectory line) is required for the peripheral monitoring system 100. The monitoring request acquisition unit 44d can receive, via the operation input unit 30 operated by the driver, a signal representing whether or not a request for the transition to the peripheral monitoring mode is made. Further, when the detection result of the shift sensor 40 acquired by the shift position acquisition unit 44c is an “R range” representing backward moving, the detection result may be acquired as information representing a request for the transition to the peripheral monitoring mode.

The coupling angle acquisition unit 44e acquires a coupling angle arising when the towed vehicle 12 is coupled to the towing vehicle 10, that is, an angle of the coupling member 20 (coupling center axis) of the towed vehicle 12 with respect to a vehicle center axis of the towing vehicle 10. The coupling angle acquisition unit 44e can detect the coupling member 20 (coupling center axis) by performing the image processing on an image based on the captured image data acquired by the image acquisition unit 44a. In addition, the coupling angle acquisition unit 44e can acquire a coupling angle θ between the towing vehicle 10 and the towed vehicle 12 by detecting a displacement angle of a turning direction of the coupling member 20 (coupling center axis) with respect to the vehicle center axis. Further, in another embodiment, when the towing device 18 is provided with an angle detection sensor, the coupling angle acquisition unit 44e may acquire the coupling angle θ on the basis of a detection value of the angle detection sensor.

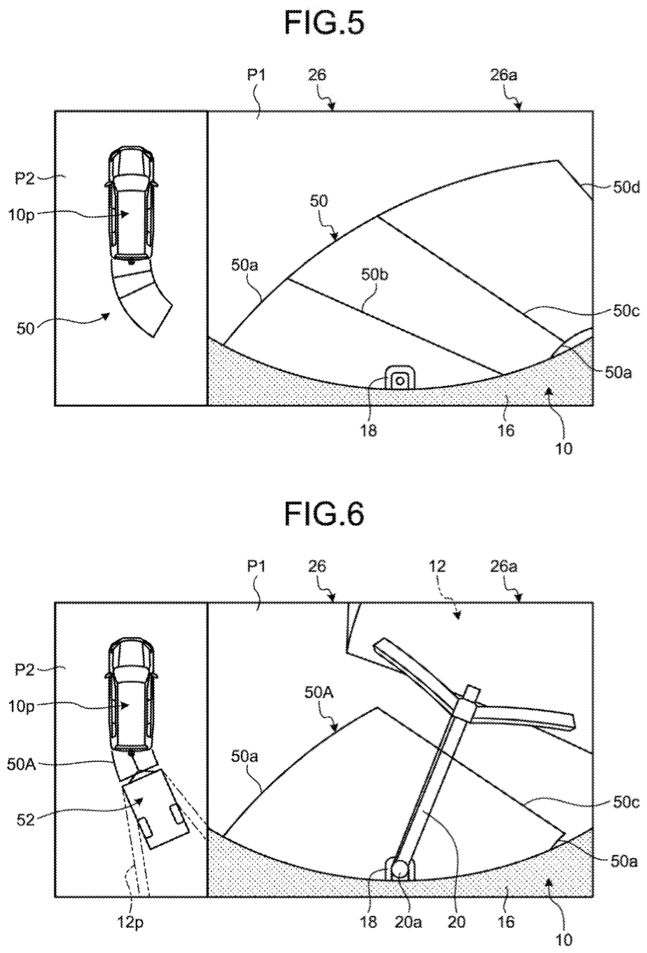

The image conversion unit 46 performs viewpoint conversion on the captured image data of the rear image of the towing vehicle 10 captured by the imaging unit 24, the front image of the towing vehicle 10, the left and right side images and combines them. The image conversion unit 46 thereby converts the images into an overlooking image of the towing vehicle 10 as looked down from the above. In the case of the present embodiment, as illustrated in FIGS. 5 and 6, the CPU 36a can arrange and display, on a screen 26a of the display device 26, a real image P1 representing the rear region of the towing vehicle 10 based on the captured image data captured by the imaging unit 24 and an overlooking image P2 converted by the image conversion unit 46. When a control state of the peripheral monitoring system 100 transits to the peripheral monitoring mode, the CPU 36a switches the screen 26a of the display device 26 from the normally displayed navigation screen or audio screen to the peripheral monitoring screen including the real image P1 and the overlooking image P2 as illustrated in FIGS. 5 and 6.

As described above, an imaging direction of the imaging unit 24 is set such that the rear region of the towing vehicle 10 including the rear bumper 16 or the towing device 18 being the rear end of the towing vehicle 10 can be imaged. Therefore, when the towed vehicle 12 is not coupled to the towing vehicle 10, as illustrated in FIG. 5, the rear bumper 16 and the towing device 18 of the towing vehicle 10 are displayed at the lower end side of the screen 26a in the real image P1, and a trajectory line 50 (first reference line) functioning as the reference line is displayed in a display region above the rear bumper 16. On the other hand, when the towed vehicle 12 is coupled to the towing vehicle 10, as illustrated in FIG. 6, the rear bumper 16 and the towing device 18 of the towing vehicle 10 are displayed at the lower end side of the screen 26a in the real image P1. In the real image P1, a trajectory line 50A (second reference line) as a reference line obtained by changing a display mode of the trajectory line 50 and the towed vehicle 12 are displayed in the display region above the rear bumper 16. As illustrated in FIGS. 5 and 6, in the present embodiment, the trajectory line 50 displayed when the towed vehicle 12 is not coupled extends to a first farthest display position to be the farthest position from the rear portion of the towing vehicle 10. Further, the trajectory line 50A displayed when the towed vehicle 12 is coupled is displayed so as to extend to a second farthest display position which is closer than the first farthest display position and is the farthest position, from the rear portion of the towing vehicle 10. The details of the trajectory lines 50 and 50A will be described later.

As illustrated in FIGS. 5 and 6, in the overlooking image P2, an vehicle image 10p corresponding to the towing vehicle 10 is displayed, and similarly to the real image P1, the trajectory lines 50 and 50A are displayed so as to extend from a rear end of the vehicle image 10p. Since the overlooking image P2 is displayed, it becomes easier to understand a peripheral condition of the towing vehicle 10. Further, since the overlooking image P2 includes the trajectory lines 50 and 50A, for example, in the case where there is an obstacle (other vehicle, a wall, or the like) around the towing vehicle 10, it is possible to easily understand a current relative positional relation between the towing vehicle 10 and the obstacle or a future relative positional relation in the case of backward moving. As described above, only the rear bumper 16 and the towing device 18 of the towing vehicle 10 are included as the rear image in the captured image data captured by the imaging unit 24 according to the present embodiment. Further, the front image or the left and right side images also include only part of the towing vehicle 10. Therefore, information (shape data) on the vehicle image 10p cannot be obtained from the captured image data. Therefore, when the overlooking image P2 is displayed, the image conversion unit 46 reads the display data of the vehicle image 10p held in advance in the ROM 36b or the like and displays the display data to be superimposed on two-dimensional data, so that the vehicle image 10p can be displayed on the overlooking image P2.

Further, when the towed vehicle 12 is included in the captured image data captured by the imaging unit 24 as illustrated in FIG. 6, a trailer image 12p corresponding to the towed vehicle 12 is included in the overlooking image P2 generated (converted) by the image conversion unit 46. In this case, when the towed vehicle 12 captured by the imaging unit 24 is converted into two-dimensional data, the trailer image 12p extending backward is obtained. Then, the vehicle image 10p is superimposed on the trailer image 12p and is displayed such that a portion corresponding to the coupler 20a (see FIG. 2) of the coupling member 20 and a portion corresponding to the towing device 18 (see FIG. 2) of the vehicle image 10p are coupled. In the case of FIG. 6, in order to clarify the presence of the towed vehicle 12, an example is illustrated, in which a trailer icon 52 corresponding to the towed vehicle 12 is displayed after superimposed onto the trailer image 12p. Similarly to the vehicle image 10p, in a case of the trailer image 12p, the display data of the trailer image 12p stored in advance in the ROM 36b or the like is read out and is displayed after superimposed onto two-dimensional data. As a result, it is possible to generate an image that looks on the overlooking image P2 as if the vehicle image 10p and the trailer image 12p (trailer icon 52) are coupled to each other. When the trailer icon 52 is displayed so as to be coupled to the vehicle image 10p, the vehicle image 10p and the trailer icon 52 can be coupled at an angle based on an actual coupling angle θ between the towing vehicle 10 and the towed vehicle 12 acquired by the coupling angle acquisition unit 44e. The vehicle image 10p and the trailer icon 52 are displayed on the overlooking image P2 when the towing vehicle 10 and the towed vehicle 12 are coupled, so that it is possible to easily understand a current coupling state between the towing vehicle 10 and the towed vehicle 12. In the case of FIG. 6, although the example in which the trailer icon 52 is displayed is illustrated, the display of the trailer icon 52 may be omitted when it is known that the towed vehicle 12 is in a coupled state.

In order to control elements displayed after superimposed on the screen 26a of the display device 26 in the peripheral monitoring mode, the control unit 48 includes modules such as a guide line generation unit 48a (generation unit), a display switching unit 48b, and a display mode control unit 48c.

When the shift position acquired by the shift position acquisition unit 44c indicates the “R range” representing a state where the vehicle can move backward, the guide line generation unit 48a generates the trajectory line 50 (guide line) representing a backward movement trajectory representing a direction in which the towing vehicle 10 and the wheels 14 move when the towing vehicle 10 is caused to move backward, on the basis of the current steering angle of the towing vehicle 10. As illustrated in FIG. 5, the trajectory line 50 includes, for example, a pair of vehicle width guide lines 50a (a right end extension line and a left end extension line) extending in a movement direction based on the steering angle of the towing vehicle 10 and representing the vehicle width of the towing vehicle 10, a plurality of distance reference lines 50b, 50c, and 50d displayed so as to straddle the pair of vehicle width guide lines 50a and representing far backward separation distances from the end (rear bumper 16) of the towing vehicle 10, and the like. In the case of FIG. 5, the trajectory line 50 displayed when a steering state of the towing vehicle 10 rotates rightward from a neutral position is illustrated. The guide line generation unit 48a can acquire a turning radius of the towing vehicle 10 from the steering angle of the towing vehicle 10 acquired by the state acquisition unit 44b, and can determine a turning shape (a turning direction, a curvature, and the like) of the trajectory line 50. The distance reference line 50b is displayed at a position corresponding to a separation distance of, for example, 0.5 m from the rear bumper 16, the distance reference line 50c is displayed at a position corresponding to a separation distance of, for example, 1.0 m from the rear bumper 16, and the distance reference line 50d is displayed at a position corresponding to a separation distance of, for example, 2.5 m from the rear bumper 16. Further, a length of the trajectory line 50 extending backward can be appropriately selected, and may be 2.5 m or more or less than 2.5 m. Further, although the three distance reference lines 50b, 50c, and 50d are illustrated, the number of distance reference lines may be less than three or four or more. Further, an interval thereof can be changed. In another embodiment, an extension line of a vehicle center line extending in a longitudinal direction of the towing vehicle 10 may be used as the trajectory line 50. In this case, one line may extend backward from the rear bumper 16, and lines similar to the distance reference lines 50b, 50c, and 50d may be provided on the line. Further, the distance reference lines 50b, 50c, and 50d may be obtained by imitating the rear bumper 16 and the rear corner of the towing vehicle 10.

When the monitoring request acquisition unit 44d acquires the request to transit to the peripheral monitoring mode, the display switching unit 48b switches the screen 26a of the display device 26 from the navigation screen or the audio screen of the normal display screen to the peripheral monitoring screen illustrated in FIG. 5 or FIG. 6. Further, when the monitoring request acquisition unit 44d acquires an end request of the peripheral monitoring mode, the display switching unit 48b returns from the peripheral monitoring screen to the normal display screen.

The display mode control unit 48c switches display modes of the trajectory line 50 and the trajectory line 50A displayed after superimposed on the real image P1 or the overlooking image P2. The switching of the display modes is performed between the case where the towed vehicle 12 is coupled to the towing vehicle 10 and the case where the towed vehicle 12 is not coupled to the towing vehicle 10. As an example, when coupling information representing that the towed vehicle 12 is not coupled is acquired by the state acquisition unit 44b, the display mode control unit 48c displays the trajectory line 50 generated by the guide line generation unit 48a as it is. That is, when the towed vehicle 12 is not coupled to the towing vehicle 10, as illustrated in FIG. 5, the display mode control unit 48c superimposes and displays, on the real image P1, the trajectory line 50 extending from the rear portion of the towing vehicle 10 to the first farthest display position, for example, 2.5 m behind the rear portion. In the case of FIG. 5, while the trajectory line 50 is bent rightward according to the steering angle of the towing vehicle 10, the distance reference line 50b representing 0.5 m behind, the distance reference line 50c representing 1.0 m behind, and the distance reference line 50d representing 2.5 m behind are displayed as the trajectory line 50 together with the vehicle width guide lines 50a. Accordingly, in the case where the towed vehicle 12 is not coupled to the towing vehicle 10, even when the trajectory line 50 extending to the first farthest display position is displayed, the possibility of interfering with other display contents is low, and simple indication can be implemented. Moreover, since the display contents are not complicated, the driver can easily understand that the trajectory line 50 is a backward movement trajectory of the towing vehicle 10. Furthermore, since the real image P1 is confirmed by the driver, it enables the user to easily recognize a predicted arrival position of the rear end of the towing vehicle 10 at the time of moving backward by 2.5 m at the current steering angle. When an obstacle such as another vehicle exists behind the towing vehicle 10, a position relation between the obstacle and the trajectory line 50 is also displayed on the real image P1. As a result, it is easy for the driver to determine whether or not the current steering angle is suitable for the backward moving.

On the other hand, when coupling information representing that the towed vehicle 12 is coupled is acquired by the state acquisition unit 44b, the display mode control unit 48c changes the display mode of the trajectory line 50 generated by the guide line generation unit 48a. For example, the trajectory line 50 displayed to the first farthest display position is changed to the trajectory line 50A extending to the second farthest display position to be a position closer to the rear portion of the towing vehicle 10. That is, when the towed vehicle 12 is coupled to the towing vehicle 10, as illustrated in FIG. 6, the display mode control unit 48c superimposes and displays, on the real image P1, the trajectory line 50A extending from the rear portion of the towing vehicle 10 to the second farthest display position, for example, 1.0 m behind the rear portion. In the case of FIG. 6, while the trajectory line 50A is bent rightward according to the steering angle of the towing vehicle 10, only the vehicle width guide lines 50a and the distance reference line 50c representing 1.0 m behind are displayed as the trajectory line 50A. Accordingly, when the towed vehicle 12 is coupled to the towing vehicle 10, the trajectory line 50A extending to the second farthest display position is displayed, so that interference between the towed vehicle 12 coupled to the towing vehicle 10 displayed on the real image P1 and the trajectory line 50A is prevented. That is, even when the trajectory line 50A is displayed in the case where the towed vehicle 12 is coupled to the towing vehicle 10, it is possible to reduce the display contents of the real image P1 being complicated. Moreover, since the trajectory line 50A does not overlap the towed vehicle 12 and the display contents are not complicated, it enables the driver to easily recognize that a relation between the towed vehicle 12 and the trajectory line 50A is low, and to easily understand that the trajectory line 50A is the backward movement trajectory of the towing vehicle 10. Furthermore, the real image P1 is confirmed by the driver, so that it enables the driver to easily recognize a predicted arrival position of the rear end of the towing vehicle 10 at the time of moving backward by 1.0 m at the current steering angle.

When the display modes of the trajectory line 50 (first reference line) and the trajectory line 50A (second reference line) are switched, the display mode control unit 48c may display the shorter trajectory line 50A extending to the second farthest display position so as to include part of the longer trajectory line 50 extending to the first farthest display position. In the cases of FIGS. 5 and 6, the vehicle width guide lines 50a and the distance reference line 50c are displayed in common in the trajectory line 50 and the trajectory line 50A. As a result, it is easy for the driver to recognize that even the trajectory line 50A displayed up to the second farthest display position is a movement position prediction line similar to the trajectory line 50, and it is easy to recognize the movement direction of the towing vehicle 10. Further, it is easy to recognize the steering state (whether the steering is at the neutral position or is rotated once and is at the same position) even with the trajectory line 50A in a short display mode.

When the towed vehicle 12 is coupled to the towing vehicle 10, the state acquisition unit 44b may acquire a coupling distance between the towing vehicle 10 and the towed vehicle 12. For example, the state acquisition unit 44b may acquire the coupling distance by performing the image processing on the rear image acquired by the image acquisition unit 44a and estimating the relative distance between the towing vehicle 10 and the towed vehicle 12 or the length of the coupling member 20. Further, the state acquisition unit 44b may cause the driver to input the length of the coupling member 20 via the operation input unit 30 or the like when the towed vehicle 12 is coupled to the towing vehicle 10. Since the length of the coupling member 20 may be different depending on the specification of the towed vehicle 12, for example, a value described in the specifications of the towed vehicle 12 to be coupled may be used, or a length candidate of the coupling member 20 prepared in advance may be selected and input by the operation input unit 30. Further, the length of the coupling member 20 may be estimated and acquired on the basis of a length of a wheel base of the towed vehicle 12 or a size of the towed vehicle 12. Further, when a distance measurement unit such as sonar is installed in the rear bumper 16 or the like of the towing vehicle 10, the distance to the towed vehicle 12 measured by the distance measurement unit may be used as the coupling distance.

The display mode control unit 48c may determine the second farthest display position of the trajectory line 50A, according to the coupling distance acquired by the state acquisition unit 44b. That is, the second farthest display position that does not overlap with the coupled towed vehicle 12 is determined and the trajectory line 50A is displayed. In this case, it is possible to reliably prevent the trajectory line 50A from being displayed to overlap the towed vehicle 12, and the driver can understand that the trajectory line 50A is the backward movement trajectory of the towing vehicle 10. Further, since the trajectory line 50A is not displayed to overlap the towed vehicle 12, simplification of the display contents of the real image P1 is reliably performed. When the second farthest display position is determined according to the coupling distance between the towing vehicle 10 and the towed vehicle 12, the second farthest display position can be set to be shorter than the coupling distance by a predetermined distance, for example, a distance corresponding to 100 mm to 200 mm. By setting the length of the trajectory line 50A as described above, the sufficiently long trajectory line 50A can be displayed within a range that does not interfere with the towed vehicle 12. As a result, although the length is shorter as compared with the case where the trajectory line 50 is displayed, it is possible to cause the driver to fully understand a future movement arrival position when the towing vehicle 10 moves backward. Further, as illustrated in FIG. 6, the trajectory line 50A can be displayed with a length where it is possible to sufficiently discriminate whether the trajectory line 50A is displayed straight or is displayed to be bent. That is, the driver can recognize whether the steering angle of the towing vehicle 10 is at the neutral position or the turning position. Further, in the case of performing the backward movement while changing the posture of the towed vehicle 12, fine adjustment of the steering angle of the towing vehicle 10 is necessary. Even in this case, the trajectory line 50A and the towed vehicle 12 are displayed without overlapping, so that it is easy to recognize a change in the trajectory line 50A or a change in the posture of the towed vehicle 12 based on the change in the steering angle. As a result, the backward moving operation of the towing vehicle 10 for changing the posture of the towed vehicle 12 can be performed more appropriately and easily. Further, when the towed vehicle 12 is turned in a desired direction, it is possible to reduce the mistake of changing the steering angle of the towing vehicle 10 in an opposite direction. That is, it becomes easy to prevent the posture change of the towed vehicle 12 from being deteriorated.

As illustrated in FIG. 5, the guide line generation unit 48a is able to generate the trajectory line 50 to be displayed on the overlooking image P2, and the display mode control unit 48c can change the display modes of the trajectory line 50 and the trajectory line 50A, on the basis of the coupling information of the towed vehicle 12 acquired by the state acquisition unit 44b. By causing the trajectory line 50 and the trajectory line 50A to be overlooked by the overlooking image P2, the backward movement trajectory of the towing vehicle 10 can be easily understood both the case where the towed vehicle 12 is not coupled and the case where the towed vehicle 12 is coupled. Further, when the towed vehicle 12 is coupled, the behavior of the towing vehicle 10 or the towed vehicle 12 can be easily understood.

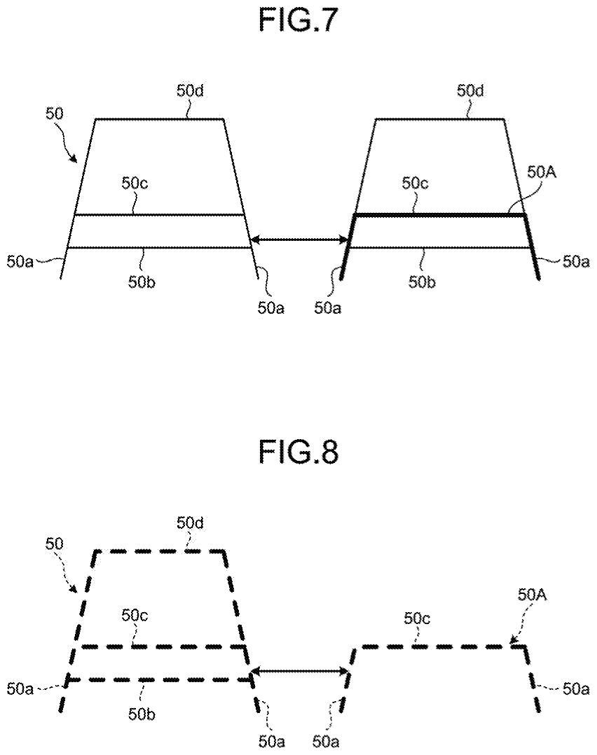

FIGS. 7 to 9 are schematic diagrams illustrating variations in the display modes of the trajectory line 50 and the trajectory line 50A. FIG. 7 is an example in which the trajectory line 50 when the towed vehicle 12 is not coupled (the left side in FIG. 7) is displayed by a thin line, and the trajectory line 50 includes the vehicle width guide lines 50a and the distance reference lines 50b to 50d. On the other hand, the trajectory line 50A when the towed vehicle 12 is coupled (right side in FIG. 7) includes the vehicle width guide lines 50a and the distance reference lines 50b to 50d, and the vehicle width guide lines 50a and the distance reference line 50c corresponding to an indication up to the second farthest display position are highlighted by a thick line. In this case, although the distance reference line 50d displayed by the thin line when the towed vehicle 12 is coupled may overlap the towed vehicle 12 on the real image P1, the trajectory line 50A is highlighted, so that it is easy to watch the trajectory line 50A. As a result, it is possible to make it difficult for the driver to feel uncomfortable or troublesome visually even when the distance reference line 50d of the thin line is displayed.

FIG. 8 illustrates an example in which the trajectory line 50 when the towed vehicle 12 is not coupled (the left side in FIG. 8) is displayed by a broken line, and the trajectory line 50 includes the vehicle width guide lines 50a and the distance reference lines 50b to 50d. On the other hand, in the trajectory line 50A when the towed vehicle 12 is coupled (right side in FIG. 8), the vehicle width guide lines 50a and the distance reference line 50c corresponding to an indication up to the second farthest display position are displayed by the broken line. In this case, since the trajectory line 50A is displayed in a minimum necessary portion by the broken line, simplicity of the display contents of the real image P1 is improved while a guide function of the trajectory line 50A is maintained, so that it is possible to improve easiness of understanding the display contents of the real image P1.

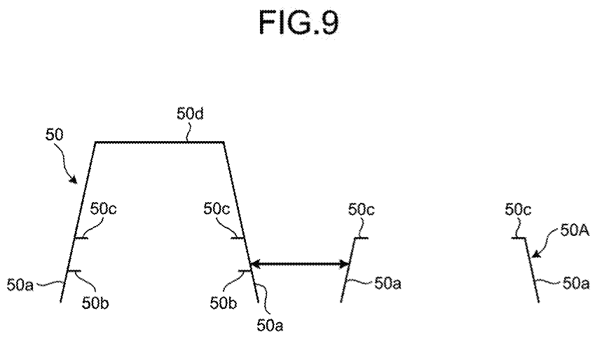

FIG. 9 illustrates an example in which the trajectory line 50 when the towed vehicle 12 is not coupled (the left side in FIG. 9) includes the vehicle width guide lines 50a, the distance reference lines 50b and 50c displayed by small pieces protruding in the vehicle width direction from part of the vehicle width guide lines 50a, and the distance reference line 50d displayed by a line connected so as to straddle the vehicle width guide lines 50a. On the other hand, the trajectory line 50A when the towed vehicle 12 is coupled (the right side in FIG. 9) is displayed by the vehicle width guide lines 50a corresponding to an indication up to the second farthest display position and the distance reference lines 50c of small pieces protruding in the vehicle width direction. Even in this case, similarly to the example of FIG. 8, since the trajectory line 50A is displayed in the minimum necessary portion, the simplicity of the display contents of the real image P1 is further improved while a guide function of the trajectory line 50A is maintained, so that it is possible to improve the easiness of understanding the display contents of the real image P1.

Even in the variations illustrated in FIGS. 7 to 9, the display mode of the trajectory line 50 or the trajectory line 50A is an example, and a sense of distance may be recognized by differently setting display colors of the distance reference lines 50b, 50c, and 50d or differently setting display colors of regions separated by the distance reference lines 50b, 50c, and 50d. Further, a length of the trajectory line 50 extending forward can be appropriately selected, and may be 2.5 m or more or less than 2.5 m. Further, although the three distance reference lines 50b, 50c, and 50d are illustrated, the number of distance reference lines may be less than three or four or more. Further, an interval thereof can be changed. Further, the change in the display modes of the trajectory line 50 and the trajectory line 50A may be implemented by switching between a lighting state and a blinking state, switching between display luminance, switching between display transmittances, and the like, and similar effects can be obtained.

As described above, in the peripheral monitoring system 100 according to the present embodiment, the display modes of the trajectory lines 50 and 50A are switched between the case where the towed vehicle 12 is coupled to the towing vehicle 10 and the case where the towed vehicle 12 is not coupled to the towing vehicle 10. Thus, it is easy to recognize a change between display contents before the coupling and display contents after the coupling. As a result, it is easy to pay attention to the trajectory lines 50 and 50A and it is easy to recognize that the backward movement trajectory of the towing vehicle 10 is displayed, so that the trajectory lines can be easily used. Further, the second farthest display position of the trajectory line 50A when the towed vehicle 12 is coupled to the towing vehicle 10 is displayed to be closer than the first farthest display position of the trajectory line 50 when the towed vehicle 12 is not coupled. As a result, it becomes easier to distinguish the trajectory lines 50 and 50A when the towed vehicle 12 is coupled and when it is not coupled. Further, when the towed vehicle 12 is not coupled, the trajectory line 50 is displayed to the distant place behind the towing vehicle 10. As a result, it is easy to perform movement prediction to the distant place when the towing vehicle 10 is moved backward at the current steering angle. Further, when the towed vehicle 12 is coupled, the second farthest display position of the trajectory line 50A is closer to the first farthest display position of the trajectory line 50, so that the towed vehicle 12 and the trajectory line 50A hardly overlap on the real image P1. As a result, it is possible to make it easier to recognize that the trajectory line 50A is the backward movement trajectory of the towing vehicle 10.

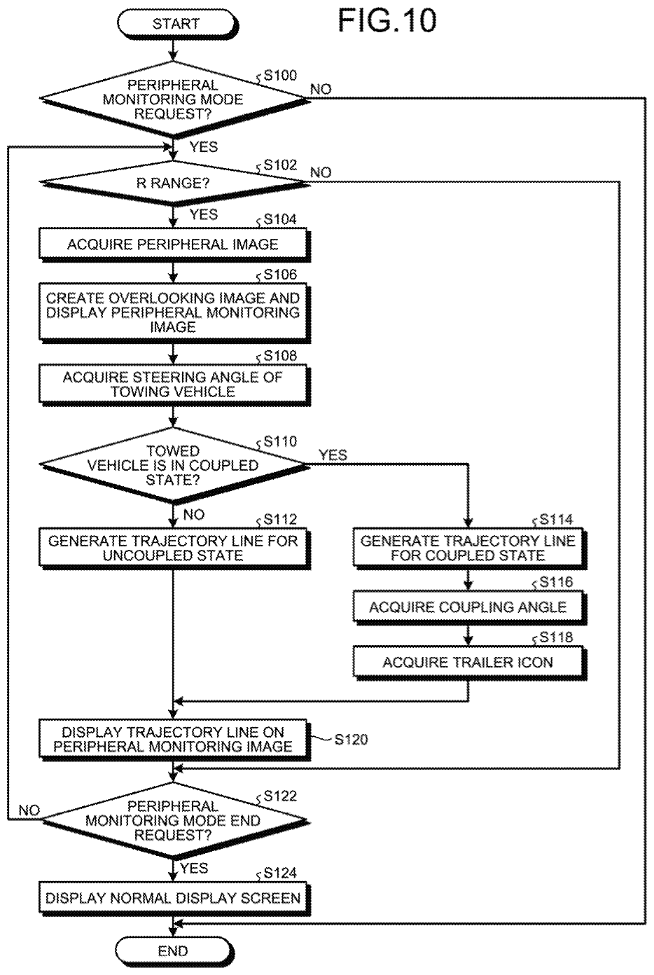

An example of a display processing procedure in peripheral monitoring by the peripheral monitoring system 100 configured as described above will be described using a flowchart of FIG. 10.

First, the CPU 36a confirms whether or not the monitoring request acquisition unit 44d has acquired a request for the transit to the peripheral monitoring mode by, for example, operating the operation input unit 30 by the driver. When the monitoring request acquisition unit 44d has not acquired the request for the peripheral monitoring mode (No in S100), the CPU 36a temporarily ends this flow. On the other hand, when the monitoring request acquisition unit 44d has acquired the request for the peripheral monitoring mode (Yes in S100), the CPU 36a confirms a direction (a forward movement or a backward movement) in which the towing vehicle 10 is currently moving, on the basis of an acquisition result of the shift position acquisition unit 44c. When the shift position acquisition unit 44c has acquired a signal representing that the driver moves the shift operation unit to the “R range” in order to move the towing vehicle 10 backward (Yes in S102), a peripheral image of the towing vehicle 10 is acquired via the image acquisition unit 44a (S104). For example, a rear image captured by the imaging unit 24, a front image captured by a front imaging unit installed in front of the towing vehicle 10, side images captured by left and right side imaging units, and the like are acquired.

Subsequently, the display switching unit 48b displays a peripheral monitoring screen by using the real image P1 using the rear image acquired by the image acquisition unit 44a and the overlooking image P2 generated by the image conversion unit 46 (S106). That is, the display switching unit 48b performs switching from the normal display screen (for example, the navigation screen or the audio screen) displayed on the screen 26a of the display device 26 before receiving the request to transit to the peripheral monitoring mode to the peripheral monitoring screen including the real image P1 and the overlooking image P2 illustrated in FIGS. 5 and 6, for example.

Subsequently, the CPU 36a acquires the steering angle of the towing vehicle 10 detected by the steering angle sensor 38 via the state acquisition unit 44b (S108). Then, the guide line generation unit 48a checks the coupling information obtained by the state acquisition unit 44b. When the towed vehicle 12 is not in a coupled state (No in S110), the guide line generation unit 48a generates the trajectory line 50 (see FIG. 5) that is the backward movement trajectory for an uncoupled state of the towed vehicle 12, based on the steering angle of the towing vehicle 10 acquired by the state acquisition unit 44b (S112). On the other hand, when the towed vehicle 12 is in the coupled state in S110 (Yes in S110), the display mode control unit 48c generates the trajectory line 50A that is a movement position prediction line for the coupled state extending from the trajectory line 50 generated by the guide line generation unit 48a according to the steering angle of the towing vehicle 10 acquired by the state acquisition unit 44b to the second farthest display position (S114). Further, the coupling angle acquisition unit 44e acquires a coupling angle θ between the towing vehicle 10 and the towed vehicle 12 (S116), and acquires the trailer icon 52 to be displayed on the overlooking image P2 (S118).

The display mode control unit 48c displays the generated trajectory line 50 or trajectory line 50A on the peripheral monitoring screen (the real image P1 and the overlooking image P2) (S120). That is, the screen 26a illustrated in FIG. 5 or FIG. 6 is displayed by the display device 26.

Then, when the monitoring request acquisition unit 44d has acquired an end request of the peripheral monitoring mode (Yes in S122), for example, when the driver has operated an end switch by using the operation input unit 30, the CPU 36a causes the display switching unit 48b to display (return) the normal display screen on the screen 26a of the display device 26 (S124). For example, the screen 26a is switched to the navigation screen or the audio screen, and a series of peripheral monitoring processing is temporarily terminated.

When the monitoring request acquisition unit 44d has not acquired the end request of the peripheral monitoring mode in S122 (No in S122), the CPU 36a proceeds to S102 and continues the peripheral monitoring processing. When the shift position acquisition unit 44c has not acquired the signal representing that the shift operation unit is moved to the “R range” in S102 (No in S102), the process proceeds to S122, and it is determined whether or not the peripheral monitoring mode is continued.

The flowchart illustrated in FIG. 10 is an example, and the peripheral monitoring system 100 may switch the display modes of the trajectory line 50 and the trajectory line 50A on the basis of the presence or absence of coupling of the towed vehicle 12. The processing steps can be appropriately changed and increased or decreased, and similar effects can be obtained.

As described above, according to the peripheral monitoring system 100 of the present embodiment, the trajectory lines 50 and 50A to be easily used at the time of backward movement in the towing vehicle 10 to which the towed vehicle 12 can be coupled can be displayed. Thus, the trajectory lines 50 and 50A can be effectively used and a sense of security is easily given to the driver.

In the embodiment described above, the display region of the overlooking image P2 is displayed smaller than the display region of the real image P1 on the display device 26. Alternatively, the overlooking image P2 may be displayed larger than the real image P1. In this case, it becomes easy for the driver to more clearly understand the posture of the towed vehicle 12 (the coupled state in view of overlooking). Further, the overlooking image P2 may be displayed on the display device 34, and only the real image P1 may be displayed on the display device 26. In this case, a wide display region of the real image P1 can be secured, and the visibility of the real image P1 can be improved. Further, when the display device 34 is installed at a position (for example, a dashboard instrument panel or the like) that can be visually recognized without significantly moving the driver's eyes during driving, the visibility of the overlooking image P2 can be improved. Further, only the overlooking image P2 may be displayed on the display device 26, and similarly, the visibility of the overlooking image P2 can be improved. Further, in the embodiment described above, the example in which the overlooking image P2 is displayed together with the real image P1 has been described. Alternatively, a system for displaying only the real image P1 may be used. In this case, the image conversion unit 46 can be omitted and the peripheral monitoring screen can be formed by using only the imaging unit 24, so that it is possible to contribute to a reduction in system cost.

In the embodiment described above, the example has been illustrated in which the trajectory line 50 functioning as the reference line includes the vehicle width guide line 50a and the distance reference lines 50b to 50d. Further, the example has been illustrated in which the trajectory line 50A functioning as the reference line includes the vehicle width guide line 50a and the distance reference line 50c. In another embodiment, the trajectory line 50 may include only the vehicle width guide line 50a or may include only the distance reference lines 50b to 50d. Similarly, the trajectory line 50A may include only the vehicle width guide line 50a or may include only the distance reference line 50c. In this case, it is possible to simplify the display contents of the real image P1 or the overlooking image P2 while maintaining the effect of recognizing the reference of the movement (movement position) of the towing vehicle 10 by the trajectory line 50 or the trajectory line 50A, and display that emphasizes the visibility such as the state or the behavior of the towed vehicle 12 and the peripheral condition of the towing vehicle 10 or the towed vehicle 12 becomes possible.

Further, in the embodiment described above, the example in which the variable reference line is displayed has been illustrated. Alternatively, a fixed reference line may be displayed. Even in this case, according to whether or not the towed vehicle 12 is coupled to the towing vehicle 10, a display mode of the vehicle width guide line or the distance reference lines of the fixed reference line (the length of the vehicle width guide line, the number of distance reference lines, the display colors, line types, or the like) can be changed. As a result, regardless of the presence or absence of coupling of the towed vehicle 12 when the towing vehicle 10 moves backward, it is easy to understand the sense of distance behind the towing vehicle 10, making it easy to drive the towing vehicle 10, and It is possible to improve the operability when 12 is coupled. Further, as described above, both the variable reference line and the fixed reference line may be displayed simultaneously. In this case, it becomes easy to recognize the change state of the variable reference line with respect to the fixed reference line, and it becomes easier to understand the turning state of the towing vehicle 10 or the towed vehicle 12, and the state of the towing vehicle 10 or the towed vehicle 12 (posture, etc.) can be made easier to recognize.

The peripheral monitoring program executed by the CPU 36a of the present embodiment may be provided as a program file stored in a computer-readable recording medium, such as a CD-ROM, a flexible disk (FD), a CD-R, and a DVD (Digital Versatile Disk), in an computer-installable format or a computer-executable format.

Further, the peripheral monitoring program may be stored on a computer connected to a network such as the Internet and provided by being downloaded over the network. Further, the peripheral monitoring program executed in the present embodiment may be provided or distributed over a network such as the Internet.

Although the embodiment and the modification of the present invention have been described, the embodiment and the modification are presented as examples and are not intended to limit the scope of the invention. These new embodiments can be implemented in other various forms, and various omissions, replacements, and changes can be made without departing from the spirit of the invention. These embodiments and modifications thereof are included in the scope and gist of the invention, and are included in the invention described in the claims and the equivalents thereof.

### EXPLANATIONS OF LETTERS OR NUMERALS

10: towing vehicle
12: towed vehicle
24: imaging unit
26: display device
36: ECU
36a: CPU
38: steering angle sensor
40: shift sensor
44: acquisition unit
44a: image acquisition unit
44b: state acquisition unit
44c: shift position acquisition unit
44d: monitoring request acquisition unit
44e: coupling angle acquisition unit
46: image conversion unit
48: control unit
48a: guide line generation unit
48b: display switching unit
48c: display mode control unit
50, 50A: trajectory line
50a: vehicle width guide line
50b, 50c, 50d: distance reference line
100: peripheral monitoring system

What is claimed is:

1. A peripheral monitoring apparatus comprising:
a hardware processor configured to:
acquire captured image data obtained by capturing, from a towing vehicle to which a towed vehicle is coupleable, a region behind the towing vehicle;
acquire coupling information representing whether or not the towed vehicle is coupled to the towing vehicle;
generate a reference line to be a reference for a movement of the towing vehicle when the towing vehicle moves backward; and
switch display modes of the reference line to be displayed after being superimposed on an image being based on the captured image data, the switching of the display modes being performed between a case where the towed vehicle is coupled to the towing vehicle and a case where the towed vehicle is not coupled to the towing vehicle.

2. The peripheral monitoring apparatus according to claim 1, wherein the hardware processor is configured to:
further acquire current steering angle information of the towing vehicle;
generate, as at least part of the reference line, a trajectory line representing at least part of a backward movement trajectory of the towing vehicle when the towing vehicle moves backward, the trajectory line being generated based on the steering angle information; and
switch display modes of the trajectory line.

3. The peripheral monitoring apparatus according to claim 1, wherein
the hardware processor is configured to perform display such that a second farthest display position is closer to a rear portion of the towing vehicle than a first farthest display position,
the first farthest display position is a farthest position from the rear portion of the towing vehicle out of position of the reference line displayed when the towed vehicle is not coupled to the towing vehicle, and
the second farthest display position is a farthest position from the rear portion of the towing vehicle out of position of the reference line displayed when the towed vehicle is coupled to the towing vehicle.

4. The peripheral monitoring apparatus according to claim 3, wherein the hardware processor is configured to determine the second farthest display position of the reference line, based on a coupling distance between the towing vehicle and the towed vehicle.

5. The peripheral monitoring apparatus according to claim 1, wherein, when the display modes of the reference line are switched, the hardware processor is configured to include part of a first reference line in a second reference line, the first reference line being displayed when the towed vehicle is not coupled to the towing vehicle, the second reference line being displayed when the towed vehicle is coupled to the towing vehicle.
